(19) United States
(12) Patent Application Publication
(10) Pub. No.: US 2015/0289227 A1
(43) Pub. Date: Oct. 8, 2015

(54) NOTIFICATION SYSTEM INCLUDING A NOTIFICATION ACCESSORY LINKABLE TO A COMMUNICATIONS DEVICE

(71) Applicants: David BECKER, Philadelphia, PA (US); Patrick BRANDON, Massapequa, NY (US)

(72) Inventors: David BECKER, Philadelphia, PA (US); Patrick BRANDON, Massapequa, NY (US)

(21) Appl. No.: 14/681,172

(22) Filed: Apr. 8, 2015

Related U.S. Application Data
(60) Provisional application No. 61/976,700, filed on Apr. 8, 2014.

(51) Int. Cl. H04W 68/00; H04M 1/22; H04W 4/00

(52) U.S. Cl. CPC H04W 68/00; H04W 4/008; H04M 1/22

(57) ABSTRACT

A notification system includes a specially-configured communications device, such as a smartphone, and a notification accessory that is linkable, e.g., via Bluetooth, to the communications device. The notification system allows a user to selectively, according to user preference, reproduce at the wearable accessory customized notifications corresponding to notifications that would otherwise occur at the communications device. The communications device includes software that allows a user to control whether and how notifications will be provided at the wearable accessory. Notifications may be made using vibratory and/or light signals, and the light signals may be provided in user-customizable colors and/or patterns. The notification accessory includes a functional module including circuitry enabling the notification accessory's functionality, and an outer housing enclosing the functional module. Various outer housings may be designed to be aesthetically appealing, e.g., as jewelry, while also being compatible with a single type of functional module.

### CROSS-REFERENCE TO RELATED APPLICATION

This application claims the benefit of priority of U.S. Provisional Patent Application No. 61/976,700, filed Apr. 8, 2014, the entire disclosure of which is hereby incorporated herein by reference.

### FIELD OF THE INVENTION

The present invention relates generally to computerized communications devices, and more particularly to a wearable electronic notification accessory capable of communicating with a communications device to provide to a wearer with notifications as a function of events identified at an associated communications device.

### BACKGROUND OF THE INVENTION

Many mobile telephones, tablet computers, laptop computers and other microprocessor-based mobile computing devices are widely commercial available. Many of these computing devices are configured to perform various computational or other tasks, and to, at certain times, provide a notification to a user of the computing device (“communications devices”). Further, many of these communications devices are capable of short-range wireless communications, e.g., via Bluetooth or Zigbee connectivity. One particular example of such a communications device having such connectivity is what is commonly referred to as a smartphone. Examples of current commercially-available smartphones including the iPhone manufactured and/or sold by Apple, Inc. of Cupertino, Calif., and the Galaxy S manufactured and/or sold by Samsung Electronics America of Ridgefield Park, N.J. These smartphones are exemplary of many communications devices in that they provide notifications to a user by issuing an audible alert (e.g., “ringing” to announce an incoming call, or “beeping” to announce a received text message, and/or displaying text via a display screen of the device, such as “John Smith calling . . . ”) to announce occurrence of an event—such as receipt of an incoming call, text message, or e-mail message. These notifications are provided essentially immediately upon occurrence of the associated event.

Particularly with respect to smartphones, many of these notifications are missed, or are not received in a timely manner by a user. This is particularly so for many women, who often carry their smartphones in a purse/handbag, etc. rather than on her person, e.g., in a pants pocket, where even if an audible or visual alert is missed, a concurrent vibration can be sensed immediately.

What is needed is a wearable electronic notification accessory capable of communicating with the communications device to provide to the wearer with notifications as a function of events identified at the associated communications device.

### SUMMARY

A notification system is provided that includes a specially-configured communications device, such as a smartphone, and a notification accessory that is linkable, e.g., via Bluetooth, to the communications device.

The notification system may be used to allow a user to reproduce at the wearable notification accessory notifications that would otherwise occur at the smartphone or other communications device, where they can be detected more readily by a user/wearer. Additionally, the notification system allows the user the prioritize and filter notifications provided at the wearable notification accessory. Accordingly, for example, notifications are provided selectively so that higher-priority notifications are issued at the wearable notification accessory while lower-priority notifications are not. Further still, the notification system can be customized so that notifications provided at the wearable notification accessory can be provided in a differentiated and user-configurable fashion. Accordingly, for example, a notification for a babysitter's call can be differentiated from a notification for a co-worker's call.

The notification accessory has two principal components, namely: a functional module including circuitry enabling the functioning of the notification accessory; and an outer housing enclosing the functional module. The outer housing is preferably designed to be aesthetically appealing, and in a most preferred embodiment, may be designed to give the impression of men's or women's jewelry.

The notification accessory is preferably sold in a retail distribution channel level as a whole. Additionally, the functional module may be sold in a wholesale distribution channel to allow for jewelry manufacturers and others to use the notification system by combining the functional module with a complementary housing of their own design, to provide a unique notification accessory/system.

### BRIEF DESCRIPTION OF THE DRAWINGS

The present invention will now be described by way of example with reference to the following drawings in which:

FIG. 1 is a left side perspective view of a communications device-linkable notification accessory in accordance with an exemplary embodiment of the present invention;

FIG. 2 is a right side perspective view of the notification accessory of FIG. 1;

FIG. 3 is a rear perspective view of the notification accessory of FIG. 1;

FIG. 4 is a front side view of the notification accessory of FIG. 1;

FIG. 5 is a top view of the notification accessory of FIG. 1;

FIG. 6 is a bottom view of the notification accessory of FIG. 1;

FIG. 7 is a left side view of the notification accessory of FIG. 1;

FIG. 8 is a right side view of the notification accessory of FIG. 1;

FIG. 9 is a back view of the notification accessory of FIG. 1;

FIG. 10 shows perspective views of an exemplary bracelet housing of the notification accessory of FIG. 1;

FIGS. 11A, and 11B show an exemplary functional module of the notification accessory of FIG. 1;

FIG. 11C shows the mating portions of a housing for housing the functional module;

FIG. 12 is a flow diagram illustrating an exemplary method involving operation of a notification system including a communications device and the notification accessory of FIG. 1;

FIG. 13 is a schematic diagram showing a communications environment including the functional components of the notification accessory of FIG. 1 and the specially-configured communications device;

FIG. 14 shows an exemplary notification system including an exemplary specially-configured communications device in accordance with the present invention and a notification accessory in accordance with the present invention; and

FIGS. 15A-15E show illustrative graphical user interface windows of a software application of an exemplary specially-configured communications device in accordance with the present invention.

### DETAILED DESCRIPTION

Conceptually, the present invention provides a “wearable tech” notification accessory, preferably including an aesthetically pleasing decorative housing, that is capable of communicating with a smartphone or other nearby communications device. The notification accessory is configured to communicate to its wearer alert notifications corresponding to alert notifications that occur on the smartphone etc., so that these alert notifications will be received promptly by the wearer, even when the wearer's smartphone, etc. is outside of the wearer's line of sight, outside of earshot of the wearer, and/or is not positioned on or against the wearer's body so that a vibratory signal could be sensed, e.g., while the smartphone, etc. is in a purse, backpack, etc.

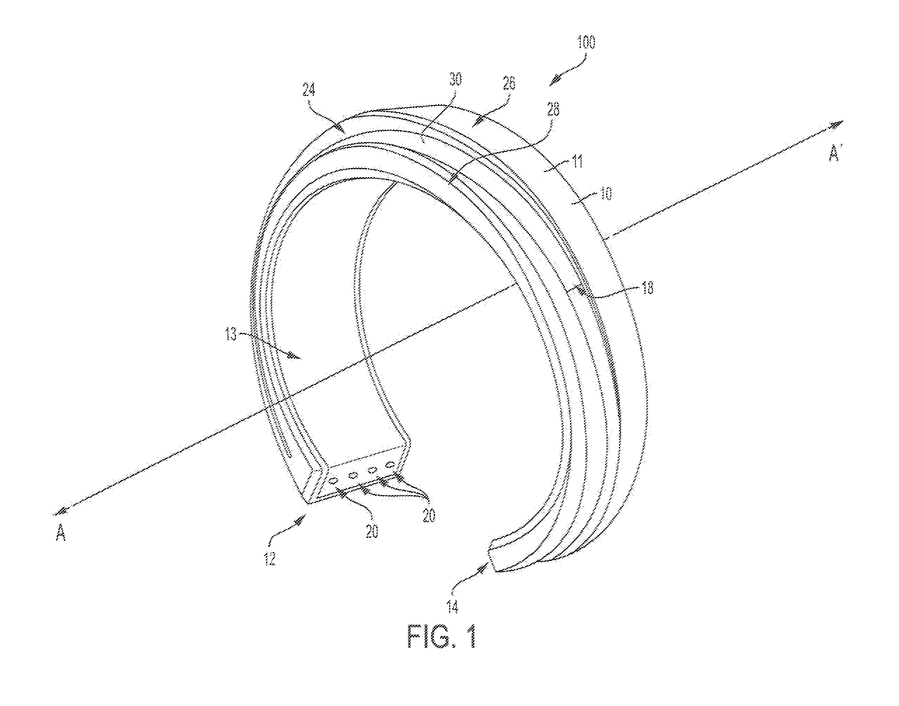

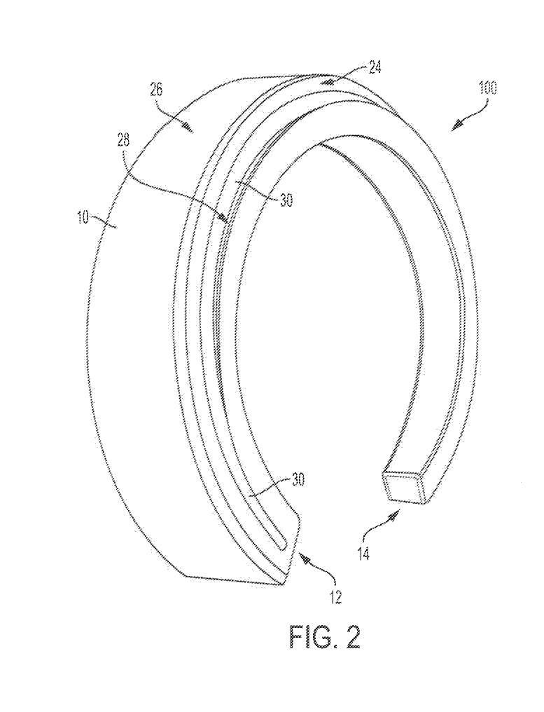

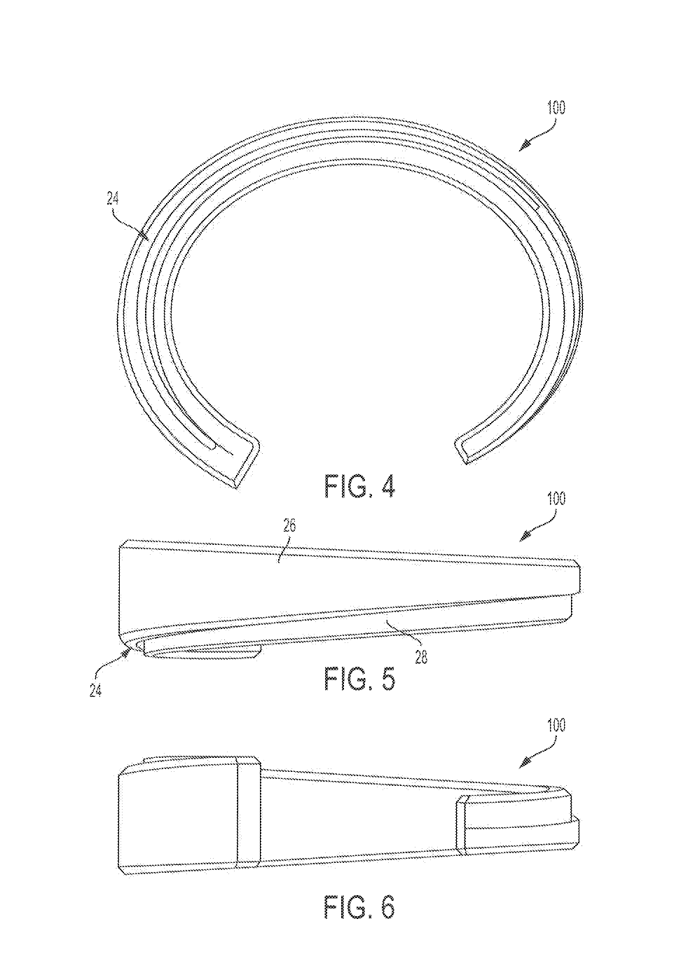

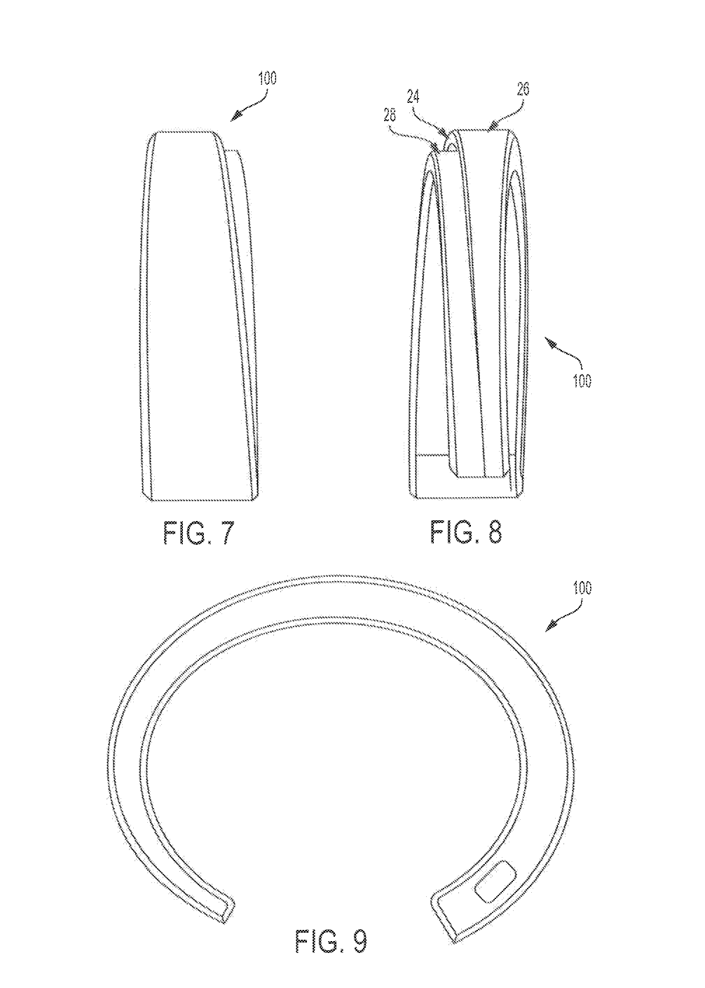

For illustrative and non-limiting purposes only, an exemplary embodiment of a notification accessory in accordance with the present invention is discussed below with reference to FIGS. 1-13. Referring now to FIGS. 1-11C, the exemplary notification accessory 100 includes an outer housing 10 configured as a wearable cuff bracelet dimensioned to be worn about the wearer's wrist. Accordingly, the housing 10 is curved in shape (e.g., about a longitudinal axis AA′) between first and second ends 12, 14, that are spaced to admit passage of an adult human wrist. The housing 10 is configured to encase the electronics/functional components of the notification accessory, as discussed below. Any suitable housing may be employed.

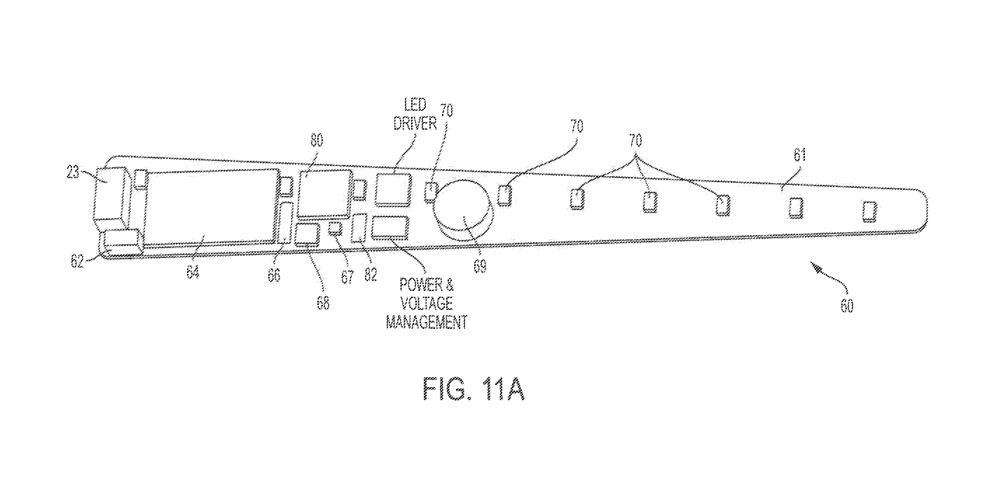

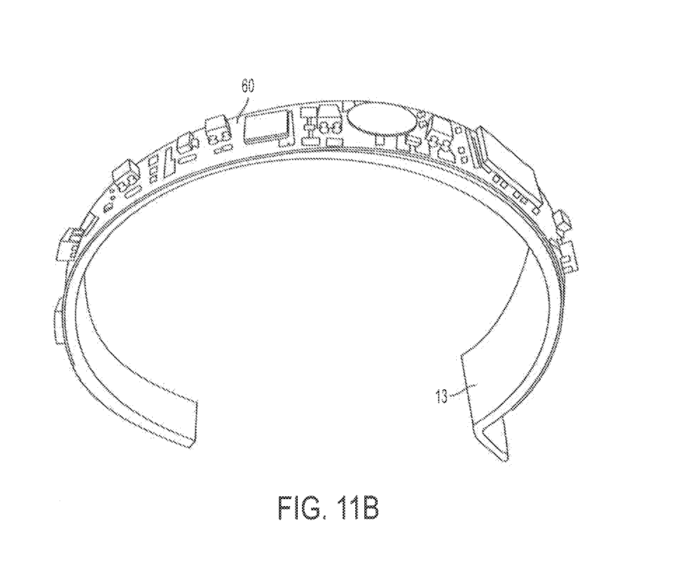

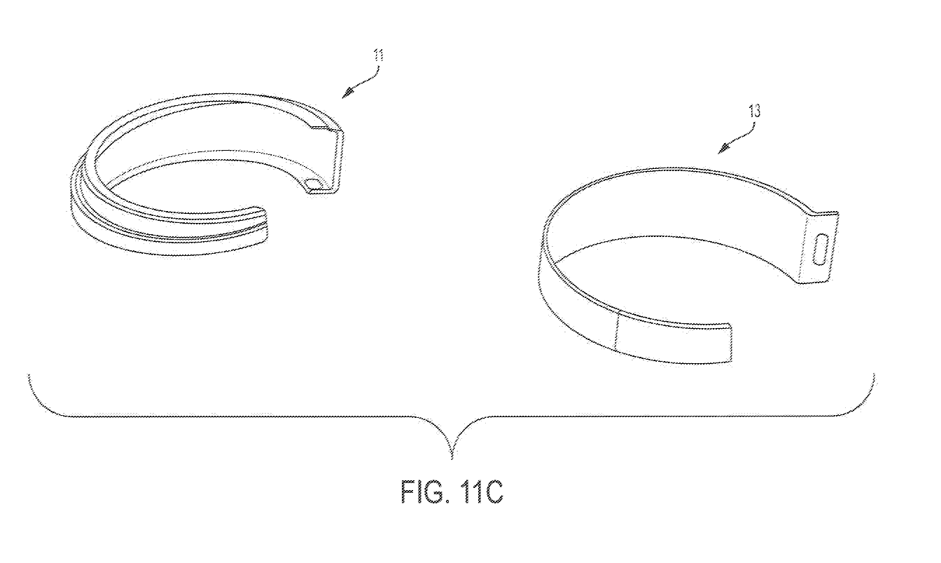

By way of example, at least a portion of the housing may be constructed of cast or machined metal. The exemplary housing 10 is configured with an aesthetically-pleasing decorative outer portion 11, preferably such that it will be perceived as men's or women's jewelry when worn. By way of example, the case may be silver- or gold-toned, and may be silver- or gold-plated. Any suitable material, color, finish and/or design may be used for the housing. In embodiments in which at least a portion of the housing is metal, to facilitate wireless communication, the housing 10 preferably further includes a non-metallic portion, such as a plastic inner portion 13, as shown in FIGS. 1 and 11C. The inner and outer portions are complementary and mate to collectively form the housing 10.

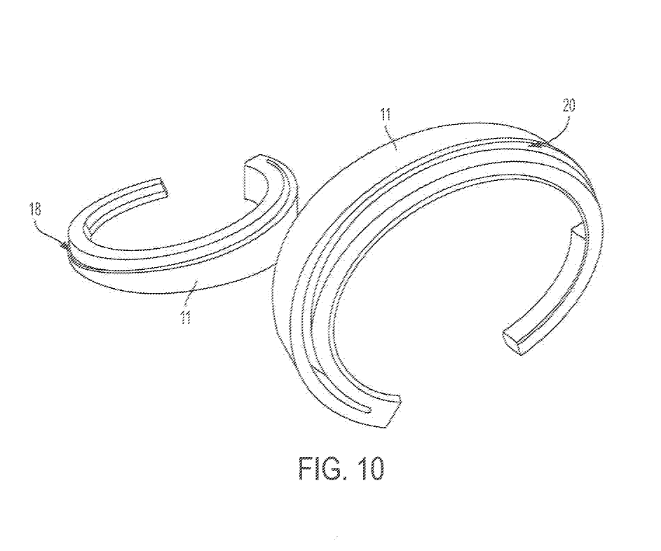

In this embodiment, the housing 10 is constructed of an opaque material but is configured to define an open window 18, as will be best appreciated from FIGS. 1 and 10. The window 18 is in communication with an interior or the housing, such that light emitted from a light source within the housing can exit through the window and be perceived by a wearer of the notification accessory, to serve as a visual notification to the wearer. In other embodiments, the housing 10 is not opaque, but rather is transparent or translucent, and thus the housing 10 may omit the window 18.

In this embodiment, the notification accessory 100 further includes a lens 30 mounted on the housing to substantially close the window 18. Thus, the lens 30 can prevent dust, dirt, debris, etc. from entering the housing 10 via the window 18. The exemplary lens 30 is constructed of a transparent or translucent material, such as plastic, to allow light to be transmitted through the lens and to be visually perceived by the wearer.

In the exemplary embodiment shown in FIGS. 1-11C, the window 18 and the lens 30 are positioned to lie on a sidewall 24 substantially disposed within a plane extending transversely and substantially normal to the longitudinal axis. In this embodiment, the housing 10 has an asymmetric design in which the sidewall 24 extends between curved but generally parallel upper 26 and lower 28 surfaces, as best shown in FIGS. 1, 2, 5 and 8.

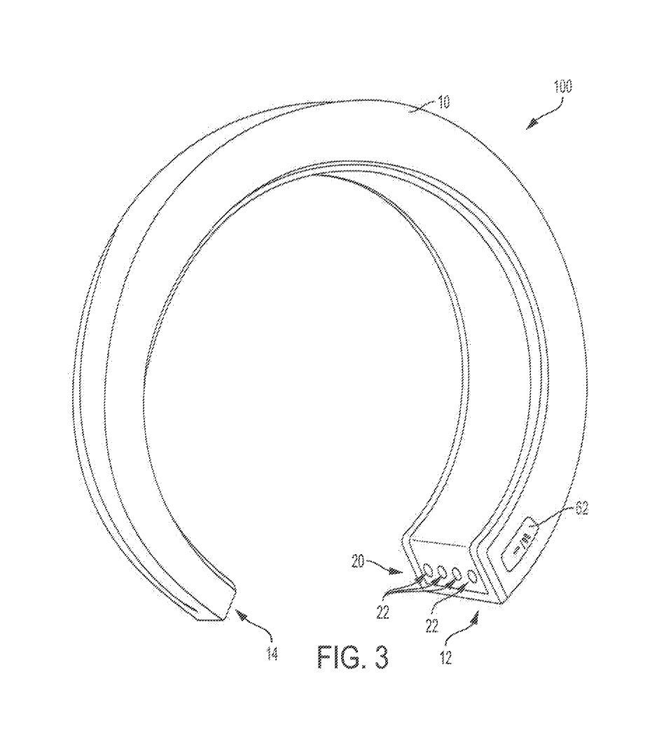

In one exemplary embodiment, the housing 10 defines at least one opening 20 to allow for making of an electrical connection between an external charging component (not shown) and a complementary battery-charging component disposed within the housing 10. In the example shown in FIGS. 1-11C, contacts 22 of a pogo-style charging component 23 are positioned within the openings 20 and the housing 10, as best shown in FIGS. 1 and 3. When the external charging component is coupled to a power source and the contacts, an internal rechargeable battery of the notification accessory can be charged. It will be appreciated that any suitable charging hardware may be used, as desired. By way of illustrative and non-limiting alternative example, a conventional micro-USB connector may be used for charging purposes.

The notification accessory 100 further includes electronic components and circuitry for enabling the functionality of the notification accessory 100. In this embodiment, the housing 10 further includes a button 62 operably connected to the circuitry (as a switch) for turning the notification accessory on and off and/or for enabling other functionality as discussed below, as best shown in FIG. 3.

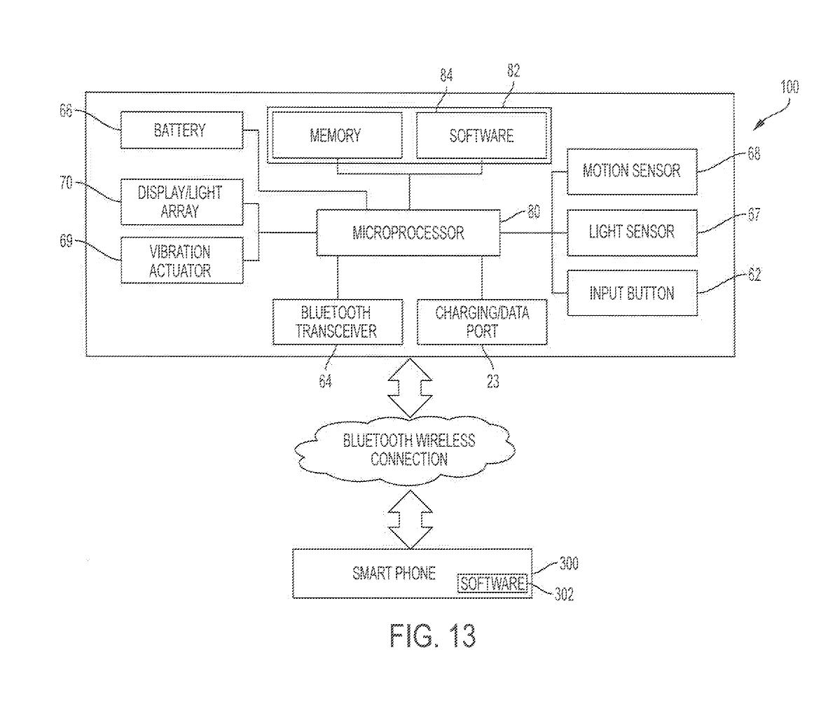

FIGS. 11A, 11B and 13 show components of a functional module 60 of the notification accessory. The functional module 60 includes the button/switch 62, a short-range wireless communication transceiver component 64 (such as Bluetooth hardware), a Li-ion or other rechargeable battery 66, a light sensor 67, a motion sensor 68 such as an accelerometer of a type similar to those used in smartphones to detect acceleration/movement/shaking input, a vibration motor 69 of a type similar to those used in smartphones to provide a vibratory alert, and at least one light source 70. These components are operably interconnected by a microprocessor 80 operatively connected to a memory 82 for storing software/instructions 84 for controlling operation of the accessory 100, as best shown in FIGS. 11A, 11B and 13.

In one embodiment, the components of the functional module 60 are supported on and operatively connected via traces of a flexible substrate 61, such as a flexible circuit board or a hybrid rigid-flexible (e.g., polyimide) printed circuit board, so that the circuitry can assume a curved orientation within an interior of the curved housing 10, as best shown in FIGS. 11A and 11B.

Preferably, the light source 70 includes a plurality of LEDs, as shown in FIGS. 11A and 11B. Preferably, the plurality of LEDs are collectively capable of providing light of different wavelengths, so as to provide, for example, red, green, blue (or other) light signals.

The notification accessory 100 of the present invention communicates with a smartphone or other communications device, which may be any commercially-available device capable of issuing alerts and communicating with the notification accessory. Accordingly, the communications device may include conventional hardware and software. However, the communications device is specially-configured in accordance with the present invention in that stores in its memory a software application 302 executable by the communications device to control communication with the notification accessory 100 in accordance with the teachings of the present invention. The software application 302 provides functionality allowing a user of the communications device 300 to establish settings for configured alerts to be issued by the notification accessory 100. For example, alerts may be configured to provide for certain types of visible alerts via the light sources 70 and/or vibratory alerts via the vibration motor 69. For example, alerts to be issued by the notification accessory 100 can be configured separately for phone alerts, text alerts, email alerts, and VIP alerts, and/or on a per-person basis.

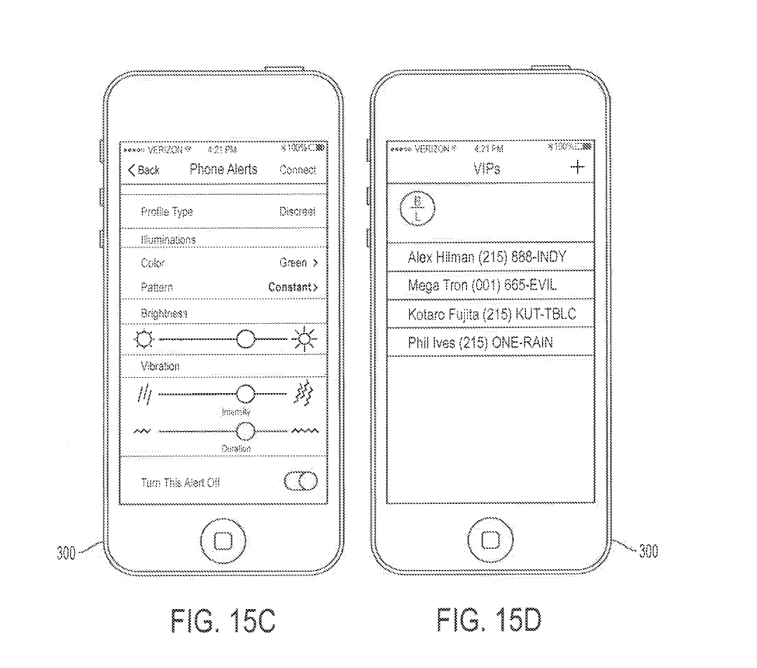

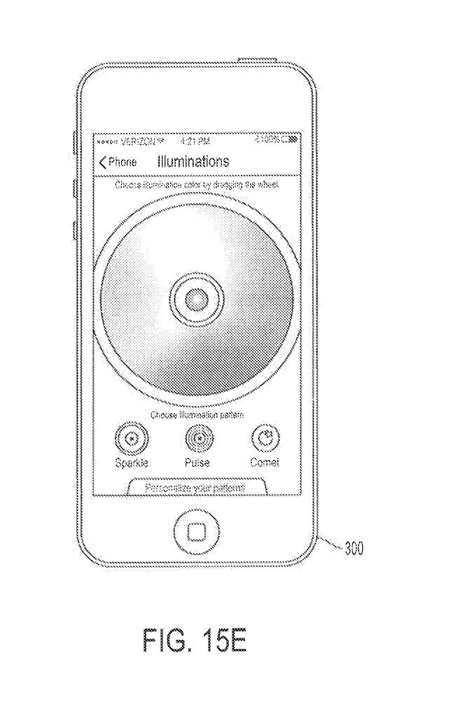

The software application 302 may be operative to allow a user to establish one or more alert profiles. The alert profiles define logic for issuing an alert at the notification device, in response to an event occurrence (such as receipt of an incoming call, receipt of an email message, or receipt of a text message) at the computing device, as will be appreciated from the graphical user interface window displayed in FIG. 15B. The logic can be defined and customized via user input provided via graphical user interface windows displayed by the software application 302 via a display screen of the communications device 300, as will be appreciated by reference to FIGS. 15A-15E. One or more alert profiles may be defined.

For example, a “discreet” alert profile may be defined to provide for use of “green” light, in a “constantly-on” pattern, with a certain brightness level, in conjunction with a vibratory signal of a certain strength and duration, as will be appreciated from the window shown in FIG. 15C. By way of further example, an “urgent” alert profile may be defined in a similar fashion, e.g., to use “red” light and intense vibration of a long duration, etc.

Further, the software application 302 may be operative to allow a user to establish a list of “high-priority” persons (“VIPs”) for whom notifications will be given preference and treated as more urgent. By way of example, the software application may be used to add individual contact information from the device's “contact list” to a VIP list maintained by the software application 302, as will be appreciated by the graphical user interface window displayed in FIG. 15D.

Further, the software application 302 is operative to configure notification modes—e.g., for movies, meetings and other times when you want to cancel illumination alerts, and receive only vibratory alerts. Further, the software application 302 is operative to act as a filter, so that (if desired) fewer than all alert notifications at the communications device will result in production of corresponding alert notifications at the notification accessory. Further, the filer is user-configurable via the software application 302.

Accordingly, various notification types can be defined, according to user preferences and input. For example, a certain LED light color can be assigned for use only for VIPs or only for certain contacts, or only for certain events. Thus, a user can configured the software application on the communications device as a filter—to associate a desired notification to events that may occur at the communication device, including receipt of calls/texts/e-mails on a per person/contact basis, on a per-class-of-person basis, on a per-profile basis, or a per-event basis. In a preferred embodiments, each notification includes a visual light/LED-based signal, an preferably the signal is provided by illumination of at least one light source, and more preferably a plurality of light sources, in one or more of a desired color, a desired color combination, a desired color pattern, a desired illumination pattern, and a desired illumination sequence. As such the notifications to be provided at the notification accessory are highly configurable according to user input/preferences provided at the communications device. The user may be permitted to select colors from a menu of colors in the form of a color wheel, as shown in FIG. 15E. Alternatively, predetermined light patterns can be selected to define a notification—e.g. ALL ON, SLOW FLASH, QUICK FLASH, PULSE, SWEEPING COMET SEQUENCE, etc. the user may be permitted to select patterns from a menu of patterns, as shown in FIG. 15E. Further, these light colors and patterns can be assigned via the software application 302 for use as intended. Vibration use and/or intensity can also be customized by user input via a user-manipulable control. See FIG. 15C.

In certain embodiments, additional notification signal definitions may be provided or be obtainable, e.g. as part of an update and/or as a result of an in-app purchase made via the software.

Further the software application 302 can be configured to provide functionality to a case-mounted button 62. For example, the button 62 may be configured to mute an active alert in response to a single-press input, to indicate a current battery level in response to a double-press input, and to toggle the notification accessory between POWER ON and POWER OFF states via press-and-hold input.

The software 302 may also provide a user interface for facilitating pairing of the notification accessory 100 with the communications device 300.

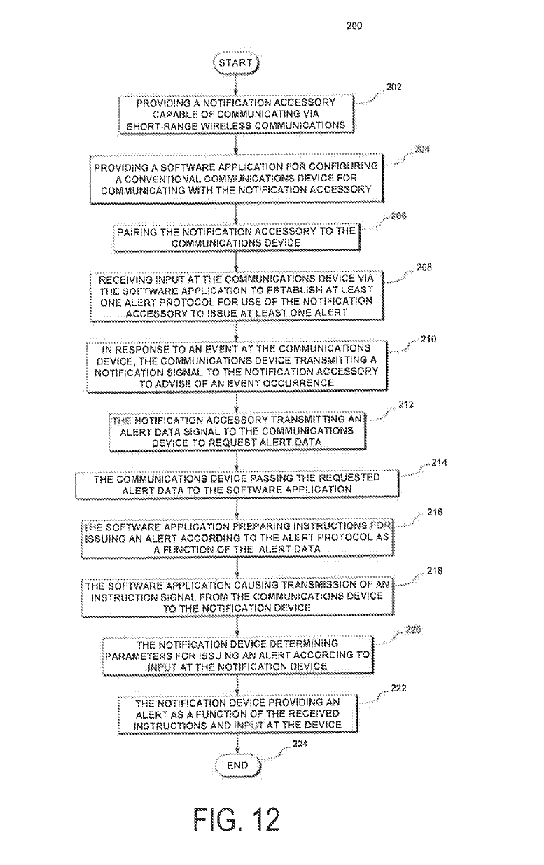

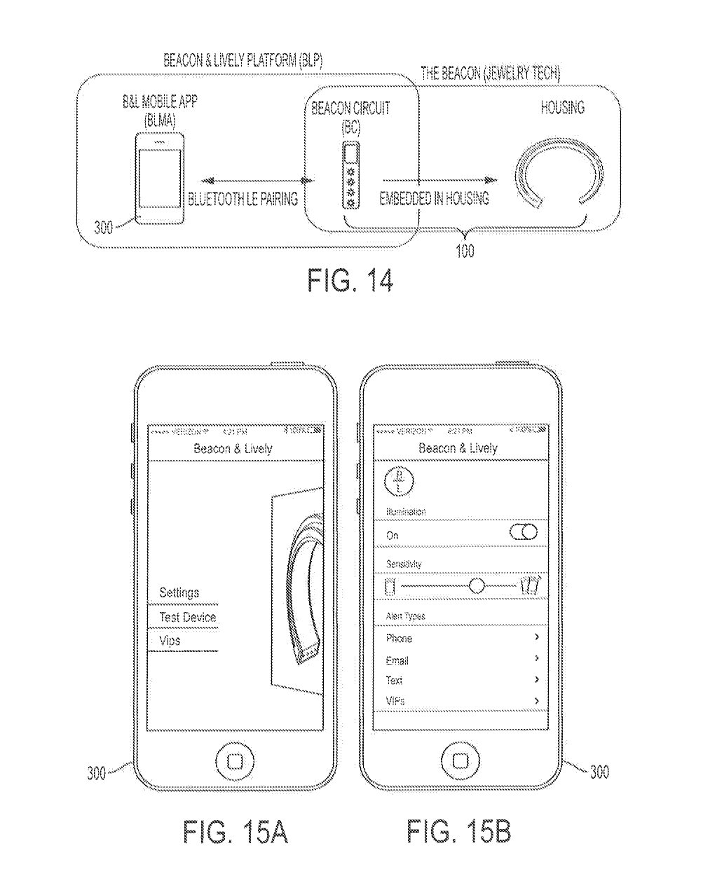

FIGS. 13 and 14 illustrate a notification system 50 including a specially-configured communications device 300 and a notification accessory 100 in accordance with an exemplary embodiment of the present invention. FIG. 12 is a flow diagram 200 showing, for illustrative and non-limiting purposes only, an exemplary method involving operation of the notification system 50. Referring now to FIGS. 12-14, the exemplary method begins with providing a notification accessory 100 capable of communication via short-range wireless communications, such as, for example, Bluetooth or Zigbee, as shown at step 202 of FIG. 12. The method further involves providing a software application 302 for configuring a conventional communications device, such as for example a smartphone, to be a specially-configured communications device 300 configured for communication with the notification accessory 100, as shown at step 204. By way of example, this step may include developing and distributing the software application 302, e.g., as a downloadable “app” accessible via the Apple iTunes AppStore or via Google Play or other app store, as well known in the art.

The exemplary method of FIG. 12 next includes pairing the notification accessory 100 to the communications device 300, as shown at step 206. This step may involve, for example, a user's downloading and installing of the software application 302 on a conventional communications device to provide the special-purpose communications device 300 (see FIG. 13), and operating the specially-configured communications device 300 in a conventional manner to establish a Bluetooth or other short range wireless communication connection between the communications device 300 and notification accessory 100. Such pairing and establishing of such a connection effectively links the device 300 and accessory 100. Hardware, software, and techniques for enabling and performing such linking are well known in the art and beyond the scope of the present invention.

The exemplary method further includes receiving input at the communications device 300, via the software application 302 and its corresponding graphical user interface, to establish at least one alert protocol for use of the notification accessory 100 to issue at least one alert, as shown at step 208. As described above, this step may involve defining alert types (e.g., by specifying one or more combinations of colors, lighting patterns, vibratory signals, etc.), and/or assigning alert types (e.g., to individual contacts, or groups of contacts (such as VIPs identified on the VIP list).

In response to an event occurring and/or detected at the communications device 300, the communications device 300 transmits a notification signal to the notification accessory 100 to advise of an event occurrence, as shown at step 210. This notification signal is sent via the Bluetooth or other short-range communication connection. The event may be any event of a type capable of detection by the communications device and issuance of an alert at the communications device, as determined by the configuration of the devices' operation system (OS) software.

It should be appreciated that in accordance with the present invention, the information relating to an event, that would normally result in issuing of an alert at the communications device, is used by the software application 302 at the communications device to identify whether, and if so how, an alert should be issued by the notification accessory 100, in accordance with logic and/or settings provided by the software application. If so, the software application communicates information necessary for providing the appropriate alert to the notification accessory. This functionality may be implemented through any combination of communication steps as necessary and/or appropriate, which will be determined in large part by the functionality, specifications and/or other aspects of the operability of the communication device's OS. As will be appreciated by those skilled in the art, any suitable communications steps may be used, as appropriate.

FIG. 12 provides an illustrative example in the context of Apple iPhones and other iOS devices. As well known in the art, iOS provides that alerts for such devices are handled by the notification center of iOS, according to the Apple Notification Center Services (ANCS) Specification, the entirety of which is hereby incorporated herein by reference. Other OS software has generally-similar functionality for managing notifications. In the context of iOS, the notification signal includes alert data, which may be limited to a “wake up” signal for the notification accessory. As managed by iOS, the notification signal essentially reports the alert event to the notification accessory 100.

The notification accessory 100 then transmits an alert data signal to the communications device 300 to request alert data, as shown at step 212. This alert data signal is sent via the Bluetooth or other short-range communication connection, and the alert data is received by the communications device 300. The alert data signal includes data to be gathered responsive to the notification signal. The alert data signal is received and/or processing under control of the communication device's operating system. In the context of iOS devices, according to the iOS notification specification, in response to the notification signal, the notification accessory then requests from the iOS device additional information related to the alert. Such additional information may include, for example, data identifying information associated with the event, such as a telephone number of a caller associated with an received telephone call, e-mail address of a received e-mail message, telephone number associated with a received text message, etc. In the context of iOS, this information may be gathered using “get notification attributes” functionality, as well-known in the art.

The communications device, particularly the OS of the communications device, provides for passing of the requested alert data to the software application 302 as a result of receipt of the alert data signal, as shown at step 214.

The software application 302 at the communications device 300 receives the alert data, e.g. notification attributes, and prepares instructions for issuing an alert according to the logic provided in the alert protocol(s), as shown at step 216. This involves processing the received data in accordance with the alert protocols and according to any other logic provided by the software application. For example, the alert data signal may include data indicating that an incoming call has been received from 555-555-5555. The software application may process this data in accordance with the alert protocol(s) to determine that 555-555-555 is associated with contact John Smith, that John Smith is not a VIP and thus should not receive a predefined VIP-style notification, but rather should receive a “discreet” notification. The software application may then determine the notification settings for a “discreet” notification according the input previously provided for a “discreet” profile (e.g., green color, constant pattern, short duration vibratory signal, etc.). Accordingly, the software application 302 may prepare notification instructions to cause the notification device to display a green color, constant pattern, short vibratory signal notification. However, other input at the software application may further inform the preparation of the instructions. For example, if a user has provided input to turn off all illumination (e.g., temporarily while in a meeting or while watching a movie), this setting may override the specified notification, e.g., to cancel the illumination and result in preparation of instructions to provide a vibratory signal only.

After preparation of instructions as a function of the alert data and the alert protocol, the software application 302 causes transmission of corresponding instruction signal from the communication device 300 to the notification accessory 100, e.g., via the Bluetooth communications channel, as shown at step 218. The instruction signal includes the data required by the notification accessory 100 to produce the desired alert at the notification device 100. In the exemplary context of iOS, the instruction signal may comprise attributes, or the processed results of attributes, provided in response to a “get app attributes” request received at the communications device from the notification device 100, under control of the device's iOS, as well-known in the art.

The notification accessory 100 receives the instruction signal and determines parameters (e.g., alert attributes) for issuing an alert according to input received at the notification accessory, as shown at step 220. For example, the light sensor 67 of the notification accessory 100 may determine an ambient light level and provide or adjust a light intensity parameter to be used in issuing a green color, constant pattern alert specified by the instructions (e.g. to increase intensity in “bright” ambient lighting, and to decrease intensity in “dim” ambient lighting).

The notification accessory 100 next produces the desired alert as a function of the data in the received instruction signal and input or instructions at the notification accessory 100, as shown at step 222, and the exemplary method ends, as shown at step 224.

It should be further noted that the motion sensor 68 may be used to provide other input, such as a “shake” or a “tap” of the notification accessory 100, at the notification accessory. Under the control of the software 82 at the notification accessory 100, the input received from the motion sensor 68 may be used to prematurely mute/silence/terminate a produced notification signal at the accessory device. Similarly, the button 62 may be used to provide other input, such as a single-press of the button 62 at the notification accessory 100. Under the control of the software 82 at the notification accessory 100, the input received from the input received via the button 62 may be used to prematurely mute/silence/terminate a produced notification signal at the accessory device.

Accordingly, the notification system 50 may be used to allow a user to reproduce notifications that would otherwise occur at the smartphone or other communications device on the wearable notification accessory 100, where they can be detected more readily by the wearer. Additionally, the notification system 50 allows the user the prioritize, and filter notifications to be provided at the wearable accessory 100. Accordingly, for example, notifications are provided selectively so that higher-priority notifications are issued at the wearable accessory while lower-priority notifications are not. Further still, the notifications can be customized so that notifications provided at the wearable accessory can be provided in a differentiated and user-configurable fashion. Accordingly, for example, a notification for a babysitter's call can be differentiated from a notification for a co-worker's call via the notification accessory.

While the invention has been particularly shown and described with reference to a preferred embodiment, it will be understood by those skilled in the art that various changes in form and detail may be made therein without departing from the spirit and scope of the invention. While there have been described herein the principles of the invention, it is to be understood by those skilled in the art that this description is made only by way of example and not as a limitation to the scope of the invention, and that various changes in detail may be effected therein without departing from the spirit and scope of the invention as defined by the claims.

What is claimed is:

1. A notification accessory for communicating with a communications device and providing an alert signal, the notification accessory comprising:
a housing,
a functional module positioned within the housing, the functional module comprising:
a microprocessor;
a memory operatively connected to the microprocessor;
a communications transceiver operably connected to the microprocessor for communicating via a short-range communications session; and
a signaling device comprising an array of discrete light sources, each of said light sources being configured to be selectively illuminated in a plurality of different configurations to provide a corresponding plurality of different notification signals in response to occurrences of a corresponding plurality of different events.

2. The notification accessory of claim 1, said functional module further comprising:
instructions stored in the memory and operable to selectively illuminate, in response to an event's occurrence detected at the communications device, the discrete light sources in a corresponding predetermined configuration in accordance with an instruction signal received via the communications transceiver from the communications device.

3. The notification accessory of claim 1, wherein the housing is curved in shape about a central axis, and wherein the functional module comprises a flexible printed circuit board capable of bending in a corresponding curved shape.

4. The notification accessory of claim 1, wherein said housing is opaque and defines a window, said functional module further comprising a lens positioned within said window, said lens being one of transparent and translucent for admitting passage of light from said light sources.

5. A functional module for providing communicating with a communications device and providing an alert signal, the functional module comprising:
a microprocessor;
a memory operatively connected to the microprocessor;
a communications transceiver operably connected to the microprocessor for communicating via a short-range communications session; and
a signaling device comprising an array of discrete light sources, each of said light sources being configured to be selectively illuminated in a plurality of different configurations to provide a corresponding plurality of different notification signals in response to an instruction signal.

6. The functional module of claim 5, further comprising:
instructions stored in the memory and operable to selectively illuminate, in response to an event's occurrence detected at the communications device, the discrete light sources in a predetermined configuration in accordance with the instruction signal, the instruction signal being received via the communications transceiver.

7. The functional module of claim 5, further comprises a vibration actuator, the instruction signal comprising information for causing the functional module to selectively power the vibration actuator in response to an event's occurrence detected at the communications device.

8. The functional module of claim 5, further comprising a motion sensor, the instruction signal further comprising instructions to cease illuminating the light sources in response to motion detected by the motion sensor.

9. The functional module of claim 5, further comprising a light sensor, the instruction signal further comprising instructions for controlling illuminating of the light sources in response to ambient light detected by the light sensor.

10. The functional module of claim 5, wherein the discrete light sources are arranged in one of a linear array and a non-linear array.

11. A notification system for communication with a communications device and providing an alert signal to a user, the notification system comprising:
a communications device comprising:
a microprocessor;
a memory operatively connected to the microprocessor;
a communications transceiver operably connected to the microprocessor for communicating via a short-range communications session; and
instructions, stored in the memory for causing the communications device to communicate via the communications transceiver to provide an instruction signal comprising instructions for issuing an alert signal at a linked device; and
a notification accessory comprising
a functional module comprising:
a microprocessor;
a memory operatively connected to the microprocessor;
a communications transceiver operably connected to the microprocessor for communicating via a short-range communications session; and
a signaling device comprising an array of discrete light sources; and
a housing enclosing the functional module;
whereby the instructions of the communications device are operable to selectively transmit to the functional module an instruction signal, the instruction signal comprising information for causing the functional module to selectively illuminate the discrete light sources in a predetermined configuration in response to an event's occurrence detected at the communications device.

12. The notification system of claim 11, wherein the instruction signal comprises instructions for selectively illuminating the discrete lights sources in a selected one of a plurality of predetermined configurations, each of said plurality of predetermined configurations corresponding to a respective one of a plurality of event types.

13. The notification system of claim 11, wherein the instruction signal comprises instructions for selectively illuminating the discrete lights sources in a selected one of a plurality of predetermined configurations, each of said plurality of predetermined configurations corresponding to a respective alert profile.

14. The notification system of claim 11, wherein the instruction signal comprises instructions for selectively illuminating the discrete lights sources in a selected one of a plurality of predetermined configurations, each of said plurality of predetermined configurations corresponding to a respective one of a plurality of individuals.

15. The notification system of claim 11, wherein the instruction signal comprises instructions for selectively illuminating the discrete light sources in a selected one of a plurality of predetermined configurations in accordance with a user's instructions for use of each of said plurality of predetermined configurations.

16. The notification system of claim 11, wherein the instruction signal comprises instructions for illuminating the discrete light sources in a specific color.

17. The notification system of claim 11, wherein the instruction signal comprises instructions for illuminating the discrete light sources in a specific color pattern.

18. The notification system of claim 11, wherein the instruction signal comprises instructions for illuminating the discrete light sources in a specific illumination pattern.

19. The notification system of claim 11, wherein the instruction signal comprises instructions for illuminating the discrete light sources in a specific illumination sequence.

20. A computer program product for specially-configuring a computerized communications device to operate as part of a notification system, the computer program product comprising:
a non-transitory computer readable medium; and
instructions stored on the computer readable medium for:
receiving user input, via the computerized communications device, to define an alert protocol;
storing the alert protocol in a memory of the computerized communications device; and
in response to receipt at the computerized communications device of alert data associated with an event:
referencing the stored alert protocol to identify an appropriate alert as a function of alert data;
preparing instructions for issuing the appropriate alert; and
causing transmission, via a transceiver of the computerized communications device, of an instruction signal comprising instructions for providing the appropriate alert.

21. The computer program product of claim 20, wherein receiving user input to define an alert protocol comprises receiving user input to associate at least one of a plurality of predetermined signaling configurations with at least one of a plurality of events.

22. The computer program product of claim 20, wherein receiving user input to define an alert protocol comprises receiving user input of an illumination pattern for a plurality of discrete lights sources.

23. The computer program product of claim 20, wherein receiving user input to define an alert protocol comprises receiving user input of an illumination sequence for a plurality of discrete lights sources.

24. The computer program product of claim 20, wherein receiving user input to define an alert protocol comprises receiving user input of at least one color for a plurality of discrete light sources.

25. The computer program product of claim 20, wherein receiving user input to define an alert protocol comprises receiving user input of a vibratory alert signal strength.

26. The computer program product of claim 20, wherein receiving user input to define an alert protocol comprises receiving user input of a vibratory alert signal duration.

27. The computer program product of claim 20, wherein the plurality of predetermined signaling configurations comprises a plurality of different colors for a plurality of discrete light sources.

28. The computer program product of claim 20, wherein the plurality of predetermined signaling configurations comprises a plurality of different illumination patterns for a plurality of discrete light sources.

29. The computer program product of claim 20, wherein the plurality of predetermined signaling configurations comprises a plurality of different illumination sequences for a plurality of discrete light sources.
